(19) United States
(12) Patent Application Publication
(10) Pub. No.: US 2005/0042342 A1
(43) Pub. Date: Feb. 24, 2005

(54) Method for producing freshly catched seafood

(76) Inventors: Asbjorn Misund, Molde (NO); Bard Misund, Bergen (NO)

Correspondence Address: RODMAN RODMAN, 7 SOUTH BROADWAY, WHITE PLAINS, NY, 10601, US

(21) Appl. No.: 10/468,504

(22) PCT Filed: Feb. 21, 2002
(86) PCT No.: PCT/NO02/00076

(30) Foreign Application Priority Data
Feb. 21, 2001 (NO) 2001/0879

(51) Int. Cl. A23K 1/00

(52) U.S. Cl. 426/327

(57) ABSTRACT

A process for the production of ready-to-prepare portions of freshly caught fish such as cod, saithe, salmon, trout etc., comprising the steps of: catch and quality control; 2) gutting and filleting; 3) deep-freezing; 3) acceptance at processing facility and quality control; 4) defrosting; 5) portioning and placing in transport or retail packaging; 6) cooling/freezing; and 8) packing, wherein a) the deep-freezing in step 3) is carried out as an “interleave” freezing of the individual fillets with interleaving to about −20° C.; b) the defrosting in step 5) is carried out in a brine solution containing 0.5-5% NaCl and 0.5-10% commercially available 60% K-Lac; c) the cooling/freezing in step 7) is carried out as a shell-freezing with CO2 saturation and cooling with CO2 in CO2 cabinets to as close to the freezing point of the product as possible, adjusted according to the intended distance of transport; d) packing in an open system where air is replaced by a mixture of N2+CO2 as a transport and packaging atmosphere.

The present invention relates to a process for the production of ready-to-prepare portions of freshly caught seafood.

Specifically, the invention relates to the production of such portions of fish such as cod, saithe, salmon, trout etc.

Fish is found in today's foodstuff market in numerous deep-frozen forms such as breaded fish products, stuffed fillets and the like, where fish products of this type are intended for frying or heating through, for example, in a pan in an oven.

Also available are non-processed deep-frozen products of the “natural” fish type, suitable for poaching.

However, the consumers' desired access to fresh fish has to date basically been limited to regular fishmonger's shops or chain stores with a separate fish counter.

The object of the present invention is to provide the market with a supply of a product that is as close to a fresh product as it is possible to get, taking into account the need for transport time.

The object of the present invention is to be able to deliver portions of fish of a quality that is not inferior to the quality of true fresh fish, and which may even be better than true fresh fish and where the product is ready to prepare upon arrival at the retailer.

The requirements made by today's society with respect to foodstuffs that are to be marketed as fresh are stringent, and of these requirements special mention should be made of traceability of the product, an extensive quality assurance requirement, and the requirement of documented shelf life.

The object of the present invention is to provide products that also meet these stringent requirements.

Accordingly, the present invention relates to a method for the production of ready-to-prepare portions of freshly caught fish such as cod, saithe; salmon, trout, etc., comprising the steps of:

1) catch and quality control;

2) gutting and filleting;

3) deep-freezing;

4) acceptance at processing facility and quality control;

5) defrosting;

6) portioning and placing in transport/retail packaging;

7) cooling/freezing; and

8) packing;

and this process is characterised in that

a) the deep freezing in step 3) is carried out as an “interleave” freezing of the individual fillets with interleaving to about −20° C.;
b) the defrosting in step 5) is carried out in a brine solution containing 0.5-5% NaCl and is 0.5-10% commercially available 60% K-Lac;
c) the cooling/freezing in step 7) is carried out as shell-freezing with CO₂ saturation, and cooling with CO₂ in CO₂ cabinets to as close to the freezing point of the product as possible, adjusted according to the intended distance of transport;
d) packing in an open system where air is replaced by a mixture of N₂+CO₂ as a transport and packaging atmosphere.

K-Lac in the present context is meant to include lactates of sodium, potassium and calcium.

The preferred values in step b) are 2% NaCl and 5% K-Lac.

Products treated in this way have a shelf life of a minimum of 12 days when stored at +4° C. without any deterioration of quality.

To the different steps in the process, the following may be added:

Immediately after the fish has been caught, the raw material is frozen on board the fishing vessels, usually within six hours.

Because quality assurance is an important feature in order to obtain the desired quality of the product described herein, the applicant has found that seiners give the best quality, although trawlers with good production and freezing routines may achieve a microbiological level that is particularly low compared with ordinary fresh fish.

Similar results may be achieved for farmed fish if they are processed or filleted no later than 2 days after slaughtering, and where the slaughtering and filleting is carried out in a controlled manner under stringent hygienic conditions.

The freezing after gutting and filleting is very important as this freezing contributes to the elimination of “smell-generating” bacteria, specifically Photobacterium phosphoreum which causes H₂S and TMA production.

The freezing in step 3) is carried out as a so-called “interleave” freezing, i.e., the individual fillet is frozen with interleaving in order to maintain the integrity of the fillet and to inhibit and prevent oxidation and dehydration

On acceptance at the final production facility, another quality control takes place before the crucial defrosting and brine treatment is carried out.

In order to maintain the quality throughout the defrosting process, the applicant has developed a method of carrying out the defrosting at the same time as the brine solution treatment.

Thus, the defrosting in step 5) is carried out in a controlled manner in a brine solution with a careful supply of power in order to maintain the temperature close to 0° C., and with simultaneous gentle handling of the individually deep-frozen fillets. It would not be a departure from the scope of this invention if the defrosting were started in air but finished in brine.

The brine solution used in this invention is a combination of water, cooking salt, and lactate, i.e., NaCl and K-Lac, in a mixture as defined above.

This mixture provides a unique preservation of quality, especially the sensory quality, whilst the defined content of the said salts contribute to the desired retention of water and prevent water loss from the product after it has been packed.

At the same time these salts prevent the growth of bacteria in general, and in particular dangerous bacteria such as Listeria.

It should perhaps be mentioned here that the authorities have approved the use of lactate, calcium lactate and cooking salt, NaCl, and that they have been used in some cases, but not in a process and in the manner described herein.

After the defrosting and the brine treatment, the pieces of fish are portioned and placed in transport or retail containers, and in step 7) a cooling/freezing of the fish using CO₂ as freezing medium is carried out when the fish is to be packed in a controlled atmosphere.

The applicant has developed a method for cooling/freezing fish which is to be packed in a modified atmosphere of CO₂ and N₂.

Of course, the scope and degree of this freezing is dependent on the fish type and the effect the process has been found to have on the sensory quality of the fish.

Thus, the degree of freezing may be from a pure shell-freezing of a few millimetres of the surface with a core temperature of about −1° C., to a deeper through freezing of the whole product to a lower temperature. The shell-freezing is preferably carried out to a temperature as close to the freezing temperature of the product as possible in CO₂ cabinets having a CO₂ atmosphere, and the degree of freezing depends not least on the distance of transport.

The temperature in the CO₂ atmosphere is preferably kept close to −60° C.

The purpose is that the product should be defrosted to a fresh state when it reaches the retail outlet.

In addition, this freezing in a partial CO₂ atmosphere results in the fish portions being saturated with CO₂, which means that CO₂ is not absorbed by the fish during transport, which in turn means that the fish maintains its transport atmosphere and thus also a tasteful wrapping.

A further purpose of this CO₂ freezing treatment is to utilise the general inhibitory effects that CO₂ has on microbial growth.

In conclusion, the special combination of steps as described according to this application allows a unique fresh food product of a high and assured quality close to the real fresh product to be obtained.

1. A process for the production of ready-to-prepare portions of freshly caught fish such as cod, saithe, salmon, trout, etc., comprising the steps of:
1) catch and quality control;
2) gutting and filleting;
3) deep-freezing;
3) acceptance at processing facility and quality control;
4) defrosting;
5) portioning and placing in transport or retail packaging;
6) cooling/freezing; and
8) packing,
characterised in that
a) the deep freezing in step 3) is carried out as an “interleave” freezing of the individual fillets with interleaving to about −20° C.;
b) the defrosting in step 5) is carried out in a brine solution containing 0.5-5% NaCl and 0.5-10% commercially available 60% K-Lac;
c) the cooling/freezing in step 7) is carried out as a shell-freezing with CO₂ saturation and cooling with CO₂ in CO₂ cabinets to as close to the freezing point of the product as possible, adjusted according to the intended distance of transport;
d) packing in an open system where air is replaced by a mixture of N₂+CO₂ as a transport and packaging atmosphere.

2. A process according to claim 1, characterised in that the defrosting in step 5) is carried out in a brine solution comprising 2% NaCl and 5% commercially available 60% K-Lac.
